(19) United States
(12) Patent Application Publication
(10) Pub. No.: US 2017/0102583 A1
(43) Pub. Date: Apr. 13, 2017

(54) MANUFACTURING METHOD OF ELECTRO-OPTIC DEVICE SUBSTRATE, ELECTRO-OPTIC DEVICE SUBSTRATE, ELECTRO-OPTIC DEVICE, AND ELECTRONIC DEVICE

(71) Applicant: Seiko Epson Corporation, Tokyo (JP)

(72) Inventor: Satoshi Ito, Eniwa-shi (JP)

(21) Appl. No.: 15/388,891

(22) Filed: Dec. 22, 2016

Related U.S. Application Data
(62) Division of application No. 14/311,892, filed on Jun. 23, 2014.

(30) Foreign Application Priority Data
Jun. 27, 2013 (JP) 2013-134624

(51) Int. Cl. G02F 1/1335; G02B 3/00

(52) U.S. Cl. CPC G02F 1/133526; G02B 3/0018; G02F 1/133512; G02F 2001/133388

(57) ABSTRACT

A manufacturing method of an electro-optic device substrate, including forming a concave portion, which corresponds to a pixel, by etching a first surface of a light transmitting substrate, forming a lens layer including a micro lens formed by filling the concave portion with a lens material having a refractive index greater than that of the substrate, flattening a second surface of the lens layer opposite to a surface in which the microlens is formed, forming a light shielding film that surrounds a display area, in which the pixel is arranged, on the flattened second surface, and forming a light transmitting path layer that covers the second surface on which the light shielding film is formed.

The present application is a divisional application of U.S. patent application Ser. No. 14/311,892 filed Jun. 23, 2014, which claims priority from Japanese Patent Application No. 2013-134624 filed Jun. 27, 2013, each of which are expressly incorporated by reference herein.

### BACKGROUND

1. Technical Field

The present invention relates to a manufacturing method of electro-optic device substrate, an electro-optic device substrate, an electro-optic device, and an electronic device.

2. Related Art

As an electro-optic device, an active driving type liquid crystal device is known in which a switching element is provided for each pixel. Further, a liquid crystal projector is known which uses such an active driving type liquid crystal device as a light valve. The light valve is a light modulation means that is provided for each color light of, for example, red (R), green (G), and blue (B) and modulates the color light based on image information. Therefore, it is required to be able to efficiently use the color light entering the light valve for a liquid crystal projector to project a bright and clear image.

For example, an electro-optic device is disclosed which includes a light condensing elements that condense incident light to pixels and a light reflector that is provided opposite to the light condensing element with respect to a liquid crystal layer and reflects a part of light passing through the liquid crystal layer to the light emitting side (JP-A-2012-226069). According to JPA-2012-226069, microlenses are provided as the light condensing elements. The microlenses are provided on either one of a pair of substrates sandwiching the liquid crystal layer. For example, the microlenses may be provided on a counter substrate arranged opposite to an element substrate, on which transistors used as switching elements are provided, with the liquid crystal layer in between. In this case, the color light enters from the counter substrate side and is condensed by the microlenses for each pixel.

The aforementioned JP-A-2012-226069 also describes a manufacturing method of the counter substrate including such microlenses. Specifically, concave portions corresponding to lens surfaces are formed by selectively etching a surface of a substrate main body of the counter substrate. The microlenses are formed by filling the concave portions with a lens material having a refractive index higher than that of the substrate main body. Thereafter, surfaces of the microlenses (bottom surfaces of the microlenses) facing the liquid crystal layer are flattened by, for example, a CMP (Chemical Mechanical Polishing) process. Then, a transparent path layer that covers the flattened surfaces is formed by using an inorganic material having substantially the same refractive index as that of the substrate main body. Further, a light shielding film that defines an opening area of a pixel is formed on a surface of the path layer facing the liquid crystal layer. Further, an interlayer film layer that covers the light shielding film is formed, a transparent conductive film is formed to cover the interlayer film layer, and a counter electrode is formed by patterning the transparent conductive film. The interlayer film layer covers the light shielding film so that a surface of the counter electrode facing the liquid crystal layer is flat.

According to the aforementioned JP-A-2012-226069, it is preferable that Formula (1) below is satisfied as an optical condition of the microlens.

f₀<=(P1×L)/W (1)

Here, f₀ is the focal length of the microlens, P1 is an arrangement pitch of the pixels, L is the length from the microlens to the light shielding film (specifically, the sum of the height of the microlens and the thickness of the path layer), and W is the width of the light shielding film. When FIG. 1) is satisfied, it is possible to efficiently condense the incident light to the opening area of the pixel.

### SUMMARY

According to Formula (1) shown in the aforementioned JP-A-2012-226069, it is required not only to form microlenses having a stable form but also to suppress the variation of the thickness of the path layer in order to efficiently condense the incident light entering the microlenses to the opening area of each pixel. A preferable method for suppressing the variation of the thickness of the path layer is to perform a flattening process such as the CMP process on the path layer. In addition, it is preferable to perform a flattening process on the interlayer film layer that covers the light shielding film so that the surface of the counter electrode facing the liquid crystal layer is flat. However, there is a problem that the productivity decreases or the manufacturing process is complicated because the flattening process is added.

Aspects of the invention are made to solve at least part of the above problem and can be realized as embodiments or application examples described below.

### Application Example 1

A manufacturing method of electro-optic device substrate according to the application example 1 includes a step of forming a concave portion, which corresponds to a pixel, by etching a first surface of a light transmitting substrate, forming a lens layer including a microlens formed by filling the concave portion with a lens material having a refractive index greater than that of the substrate, flattening a second surface of the lens layer opposite to a surface in which the microlens are formed, forming a light shielding film that surrounds a display area, in which the pixel is arranged, on the flattened second surface, and forming a light transmitting path layer that covers the second surface on which the light shielding film is formed.

According to the application example 1, the light shielding film that surrounds the display area is formed on the flattened second surface of the lens layer and then the path layer is formed, so that it is not necessary to form the interlayer film layer that covers the light shielding film described in the aforementioned JP-A-2012-226069. As a result, it is possible to provide a manufacturing method of electro-optic device substrate, which can simplify the manufacturing process, realize high productivity, and manufacture an electro-optic device substrate including microlenses, each of which corresponds to each of a plurality of pixels.

The manufacturing method of electro-optic device substrate according to the above application example further includes a step of forming a transparent conductive film on a third surface of the path layer opposite to a side in contact with the lens layer. According to this method, it is possible to manufacture an electro-optic device substrate including a transparent conductive film in addition to the microlenses with high productivity.

It is preferable that the manufacturing method of electro-optic device substrate according to the above application example further includes a step of flattening the third surface of the lens layer before the step of forming the transparent conductive film. According to this method, it is possible to manufacture an electro-optic device substrate including a transparent conductive film whose surface is flattened with high productivity.

### Application Example 2

An electro-optic device substrate according to the application example 2 includes a light transmitting substrate, a lens layer including a microlens which is formed corresponding to a pixel in the substrate, the microlens having a lens surface that is a concave portion filled with a lens material whose refractive index is greater than that of the substrate, a light shielding film provided on a second surface of the lens layer opposite to a side on which the microlens are provided so that the light shielding film surrounds at least a display area in which the pixel are arranged, and a light transmitting path layer provided so as to cover the light shielding film on the second surface.

According to the electro-optic device substrate according to the application example 2, it is not necessary to provide the interlayer film layer that covers the light shielding film described in the aforementioned JPA-2012-226069 as compared with a case in which a light shielding film is provided on a surface of the path layer opposite to the second surface. In other words, it is possible to cause the path layer to function as the interlayer film layer. As a result, it is possible to provide an electro-optic device substrate of a simple configuration, which includes microlenses at positions corresponding to each of a plurality of pixels.

It is preferable that the electro-optic device substrate according to the above application example further includes a transparent conductive film that covers a third surface of the path layer opposite to a side of the light shielding film. According to this configuration, it is possible to provide an electro-optic device substrate including a transparent conductive film that can be used as an electrode in addition to the microlenses.

It is preferable that a flattening process is performed on the third surface of the path layer in the electro-optic device substrate according to the above application example. According to this configuration, it is possible to provide an electro-optic device substrate including a transparent conductive film whose surface is flat.

It is preferable that a flattening process is performed on the second surface of the lens layer in the electro-optic device substrate according to the above application example. According to this configuration, it is possible to provide an electro-optic device substrate including microlenses having stable light condensing performance as compared with a case in which the flattening process is not performed on the second surface.

In the electro-optic device substrate according to the above application example, the concave portion are formed by etching a first surface of the substrate. According to this configuration, it is possible to realize the concave portions as smooth lens surfaces as compared with a case in which the concave portions are formed by cutting the first surface. As a result, it is possible to provide an electro-optic device substrate including microlenses having more stable light condensing performance.

In the electro-optic device substrate according to the above application example, it is preferable that the light shielding film includes a portion arranged so as to overlap portion of the lens layer where no microlens is provided in a diagonal direction of the pixel in the second surface. According to this configuration, for example, when microlenses having an approximately circular shape in a plan view are arranged corresponding to pixels, a portion in which no microlens is provided is generated between pixels adjacent to each other in a diagonal direction, so that it is possible to provide an electro-optic device substrate in which light leakage between pixels is reduced by arranging the light shielding film so as to overlap the portions.

In the electro-optic device substrate according to the above application example, the light shielding film may include a portion provided so as to define an opening area of the pixel in the second surface. According to this configuration, it is possible to shield light entering from the periphery of the opening area of the pixels by the light shielding film. Therefore, when the electro-optic device substrate of the present application example is used, it is possible to realize an electro-optic device which has high contrast and can present a bright display.

### Application Example 3

An electro-optic device according to the application example 3 includes a pair of substrates and a liquid crystal layer clamped between the pair of substrates, and an electro-optic device substrate manufactured by using the manufacturing method of electro-optic device substrate according to the above application example is used as one of the pair of substrates.

### Application Example 4

An electro-optic device according to the application example 4 includes a pair of substrates and a liquid crystal layer clamped between the pair of substrates, and the electro-optic device substrate according to the above application example is used as one of the pair of substrates. According to these application examples, bright display can be performed and manufacturing can be performed with high productivity, so that it is possible to provide an electro-optic device having excellent cost performance.

### Application Example 5

An electronic device according to the application example 5 includes the electro-optic device according to the above application examples. According to the application example 5, bright display can be performed and manufacturing can be performed with high productivity, so that it is possible to provide an electronic device having excellent cost performance.

### BRIEF DESCRIPTION OF THE DRAWINGS

The invention will be described with reference to the accompanying drawings, wherein like numbers reference like elements.

FIG. 1 is a schematic plan view showing a configuration of a liquid crystal device according to a first embodiment.

FIG. 2 is an equivalent circuit diagram showing an electrical configuration of the liquid crystal device according to the first embodiment.

FIG. 3 is a schematic cross-sectional view showing a structure of the liquid crystal device taken along line III-III in FIG. 1.

FIG. 4A is a schematic plan view showing an arrangement of microlenses in a microlens array substrate.

FIG. 4B is a schematic plan view showing an arrangement of a light shielding film with respect to the microlenses.

FIG. 5A is a main portion cross-sectional view of the microlens array substrate taken along line VA-VA in FIG. 4B.

FIG. 5B is a main portion cross-sectional view of the microlens array substrate taken along line VB-VB in FIG. 4B.

FIG. 6 is a flowchart showing a manufacturing method of the microlens array substrate.

FIGS. 7A to 7D are schematic cross-sectional views showing the manufacturing method of the microlens array substrate.

FIGS. 8A to 8D are schematic cross-sectional views showing the manufacturing method of the microlens array substrate.

FIG. 9 is a schematic diagram showing a configuration of a projection type display device.

FIG. 10 is a schematic plan view showing an arrangement of a light shielding film with respect to microlenses of a modified example.

### DESCRIPTION OF EXEMPLARY EMBODIMENTS

Hereinafter, embodiments exemplifying the invention will be described with reference to the drawings. The drawings to be used are enlarged or reduced as needed so that a portion to be explained can be recognized.

In the embodiments described below, for example, when a phrase of “a thing on the substrate” is written, this represents a case in which the thing is placed in contact with the substrate, a case in which the thing is placed above the substrate with another component in between, or a case in which a part of the thing is placed in contact with the substrate and a part of the thing is placed above the substrate with another component in between.

### First Embodiment

### Electro-Optic Device

As an electro-optic device of the present embodiment, an active matrix type liquid crystal display device including thin film transistors (TFTs) as switching elements for pixels will be described as an example. For example, the liquid crystal device can be preferably used as an optical modulator (liquid crystal light valve) of a projection type display device (liquid crystal projector) described later.

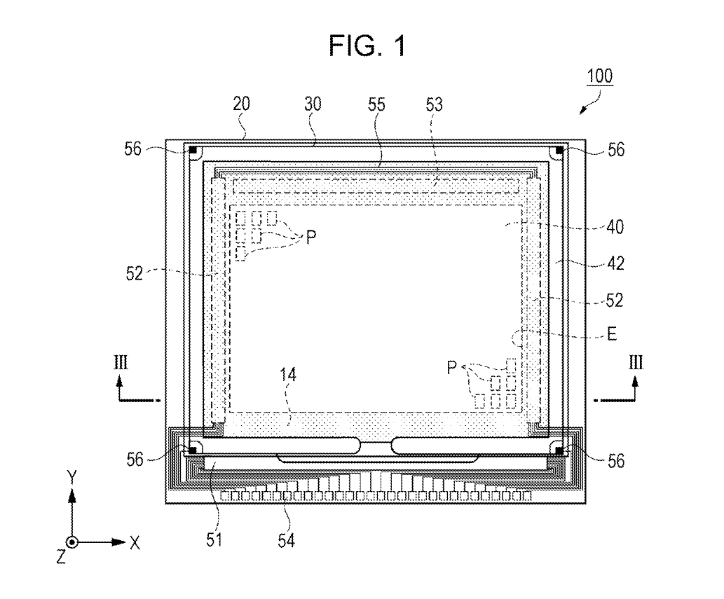

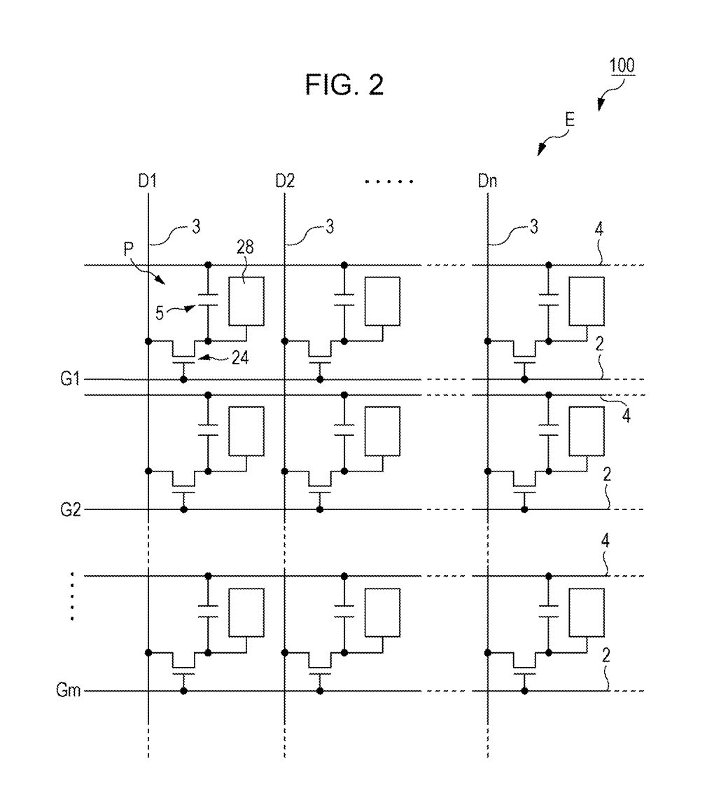

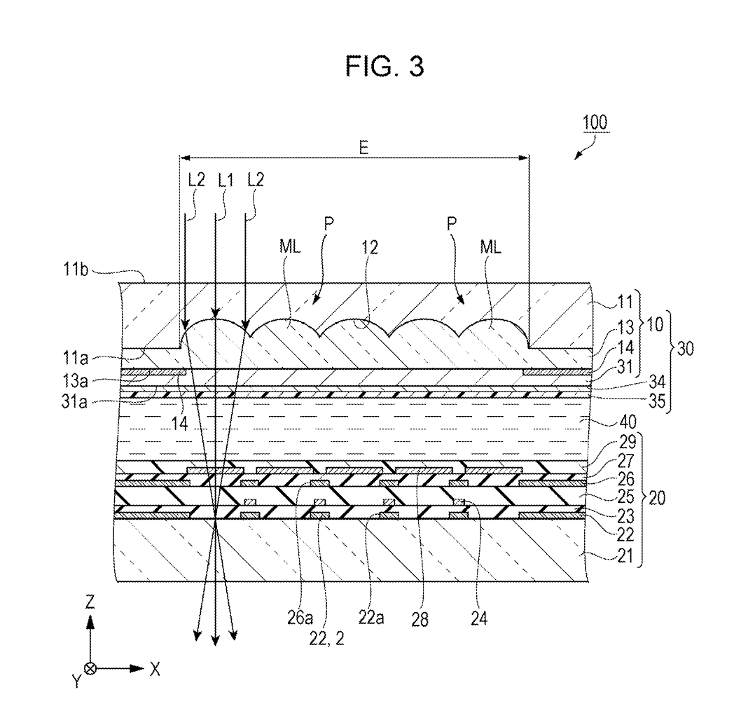

First, the liquid crystal device, which is the electro-optic device of the present embodiment, will be described with reference to FIGS. 1, 2, and 3. FIG. 1 is a schematic plan view showing a configuration of the liquid crystal device according to the first embodiment. FIG. 2 is an equivalent circuit schematic showing an electrical configuration of the liquid crystal device according to the first embodiment. FIG. 3 is a schematic cross-sectional view showing a structure of the liquid crystal device taken along line III-III in FIG. 1.

As shown in FIGS. 1 and 3, the liquid crystal device 100 includes an element substrate 20 and a counter substrate 30 which are arranged to face each other and a liquid crystal layer 40 arranged between the element substrate 20 and the counter substrate 30. As shown in FIG. 1, the element substrate 20 is a size larger than the counter substrate 30 and both substrates are bonded together through a seal member 42 arranged in a frame shape along the outer edge of the counter substrate 30.

The liquid crystal layer 40 includes a liquid crystal which has a positive or negative dielectric anisotropy and is sealed in a space surrounded by the element substrate 20, the counter substrate 30, and the seal member 42. The seal member 42 includes, for example, an adhesive of thermosetting or ultraviolet curable epoxy resin. The seal member 42 is mixed with spacers (not shown in the drawings) for maintaining a distance between the element substrate 20 and the counter substrate 30.

A display area E including a plurality of pixels P arranged in a matrix form is provided inside the seal member 42 arranged in a frame shape. A parting member 14 is provided between the seal member 42 and the display area E so as to surround the display area E. The parting member 14 is formed of, for example, a light shielding metal or metal compound. The display area E may include dummy pixels arranged to surround the pixels P in addition to the pixels P that contribute to display. Although described later in detail, microlenses, each of which is a light condensing means and is arranged for each of the pixels P in the display area E, and a light shielding film are provided on the counter substrate 30.

A terminal unit in which a plurality of external connection terminals 54 are arranged is provided on the element substrate 20. A data line drive circuit 51 is provided between a first side along the terminal unit of the element substrate 20 and the seal member 42. A test circuit 53 is provided between the seal member 42 along a second side opposite to the first side and the display area E. Further, a scanning line drive circuit 52 is provided between the seal member 42 along third and fourth sides, which are perpendicular to the first side and opposite to each other, and the display area E. A plurality of wirings 55 that connect the two scanning line drive circuits 52 to each other are provided between the seal member 42 along the second side and the test circuit 53. The arrangement of the test circuit 53 is not limited to this, and the test circuit 53 may be provided at a position along the inner side of the seal member 42 between the data line drive circuit 51 and the display area E.

Wirings connected to the data line drive circuit 51 and the scanning line drive circuits 52 are connected to the external connection terminals 54 arranged along the first side. In the description below, the direction along the first side is referred to as an X direction and the direction along the third side is referred to as a Y direction. The X direction is a direction along the line III-III in FIG. 1. A direction which is perpendicular to the X direction and the Y direction and which is an upward direction in FIG. 1 is referred to as a Z direction. In the present specification, seeing from the normal direction (Z direction) of a surface 11b (see FIG. 3) of the counter substrate 30 of the liquid crystal device 100 is referred to as “in a plan view”.

Next, an electrical configuration of the liquid crystal device 100 will be described with reference to FIG. 2. The liquid crystal device 100 includes a plurality of scanning lines 2 and a plurality of data lines 3, which are signal lines insulated from each other and perpendicular to each other at least in the display area E, and capacitance lines 4 each of which is arranged in parallel with each of the scanning lines 2. The direction in which the scanning lines 2 extend is the X direction. The direction in which the data lines 3 extend is the Y direction.

In each of areas divided by the scanning lines 2, the data lines 3, and the capacitance lines 4, a pixel electrode 28, a TFT 24, and a storage capacitor 5 are provided and these components constitute a pixel circuit of the pixel P.

The scanning line 2 is electrically connected to the gate of the TFT 24 and the data line 3 is electrically connected to the source of the TFT 24. The pixel electrode 28 is electrically connected to the drain of the TFT 24.

The data lines 3 are connected to the data line drive circuit 51 (see FIG. 1) and supply image signals D1, D2, . . . , and Dn supplied from the data line drive circuit 51 to the pixels P. The signal lines 2 are connected to the scanning line drive circuit 52 (see FIG. 1) and supply scanning signals G1, G2, . . . , and Gm supplied from the scanning line drive circuit 52 to the pixels P.

The image signals D1 to Dn supplied from the data line drive circuit 51 to the data lines 3 may be line-sequentially supplied in this order or may be supplied for each group of a plurality of data lines 3 adjacent to each other. The scanning line drive circuit 52 line-sequentially supplies the scanning signals G1 to Gm to the scanning lines 2 in a pulse at a predetermined timing.

The liquid crystal device 100 has a configuration in which the TFTs 24, which are switching elements, are turned on for a certain period of time by the input of the scanning signals G1 to Gm, so that the image signals D1 to Dn supplied from the data lines 3 are written to the pixel electrodes 28 at a predetermined timing. Then, the image signals D1 to Dn of a predetermined level written to the liquid crystal layer 40 through the pixel electrodes 28 are held for a predetermined period of time between the pixel electrodes 28 and a common electrode 34 (see FIG. 3) arranged opposite to the pixel electrodes 28 with the liquid crystal layer 40 in between. The frequency of the image signals D1 to Dn is, for example, 60 Hz.

To prevent the held image signals D1 to Dn from leaking out, the storage capacitor 5 is connected in parallel with a liquid crystal capacitance formed between the image electrode 28 and the common electrode 34. The storage capacitor 5 is provided between the drain of the TFT 24 and the capacitance line 4.

Although the data lines 3 are connected to the test circuit 53 shown in FIG. 1 and an operational defect and the like of the liquid crystal device 100 can be checked by detecting the image signals in a manufacturing process of the liquid crystal device 100, this is not shown in the equivalent circuit shown in FIG. 2.

A peripheral circuit that drives and controls the pixel circuit in the present embodiment includes the data line drive circuit 51, the scanning line drive circuit 52, and the test circuit 53. The peripheral circuit may include a sampling circuit that samples the image signal and supplies the image signal to the data line 3 and a precharge circuit that supplies a precharge signal of a predetermined voltage level to the data line 3 before the image signal is supplied.

Next, a structure of the liquid crystal device 100 will be described with reference to FIG. 3. As shown in FIG. 3, the element substrate 20 includes a light transmitting substrate main body 21 and further includes a first light shielding layer 22, an insulating film 23, the TFTs 24, a first interlayer insulating film 25, a second light shielding layer 26, a second interlayer insulating film 27, the pixel electrodes 28, and an oriented film 29. A light transmitting material such as glass or quartz is used for the substrate main body 21.

For the first light shielding layer 22 and the second light shielding layer 26, for example, a metal single body, an alloy, a metal silicide, a polysilicide, or a nitride, which includes at least one of the following metals: Al (aluminum), Ti (titanium), Cr (chrome), W (tungsten), Ta (tantalum), Mo (molybdenum), and the like, or a laminate of these can be used. The first light shielding layer 22 and the second light shielding layer 26 have both a light shielding property and a conductive property. The first light shielding layer 22 is formed in a grid pattern so as to overlap the upper second light shielding layer 26 in a plan view and arranged so that the first light shielding layer 22 and the second light shielding layer 26 sandwich the TFTs 24 in between them in the thickness direction (Z direction) of the element substrate 20. Incident light to the TFTs 24 is suppressed by the first light shielding layer 22 and the second light shielding layer 26. Areas surrounded by the first light shielding layer 22 and the second light shielding layer 26 (openings 22a and 26a) are opening areas through which light passes through the element substrate 20.

The insulating film 23 is provided so as to cover the substrate main body 21 and the first light shielding layer 22. The insulating film 23 is formed of, for example, an inorganic material such as SiO₂. The TFTs 24 are provided on the insulating film 23. Although not shown in the drawings, the TFT 24 includes a semiconductor layer, a gate electrode, a source electrode, and a drain electrode.

The gate electrode is arranged opposite to an area overlapping a channel area of the semiconductor layer in a plan view through a part of the first interlayer insulating film 25 (gate insulating film) in the element substrate 20. The first light shielding layer 22 is patterned so that a part of the first light shielding layer 22 functions as the scanning line 2 (see FIG. 2). The gate electrode is electrically connected to the scanning line 2 arranged in a lower layer through a contact hole penetrating the gate insulating film and the insulating film 23.

The first interlayer insulating film 25 is provided so as to cover the insulating film 23 and the TFTs 24. The first interlayer insulating film 25 is formed of, for example, an inorganic material such as SiO₂. The first interlayer insulating film 25 includes the gate insulating film that insulates between the semiconductor layer and the gate electrode of the TFT 24. The first interlayer insulating film 25 reduces surface unevenness due to the TFTs 24. The second light shielding layer 26 is provided on the first interlayer insulating film 25. The second light shielding layer 26 is patterned to function as, for example, any one of electrodes of the data line 3, the capacitance line 4, and the storage capacitor 5, which are electrically connected to the TFT 24. The second interlayer insulating film 27 formed of an inorganic material is provided so as to cover the first interlayer insulating film 25 and the second light shielding layer 26.

The pixel electrode 28 is formed of, for example, a transparent conductive film such as ITO (Indium Tin Oxide) and IZO (Indium Zinc Oxide) and provided on the second interlayer insulating film 27 corresponding to the pixel P. The pixel electrode 28 is arranged in an area overlapping the opening 22a of the first light shielding layer 22 and the opening 26a of the second light shielding layer 26a in a plan view. The outer edge of the pixel electrode 28 is arranged so as to overlap the second light shielding layer 26 in a plan view.

For the oriented film 29 that covers the pixel electrodes 28, it is possible to use an organic resin material such as, for example, polyimide that can substantially horizontally orient liquid crystals (liquid crystal molecules) having positive dielectric anisotropy or an inorganic material such as, for example, silicon oxide that can substantially vertically orient liquid crystals (liquid crystal molecules) having negative dielectric anisotropy.

In the liquid crystals included in the liquid crystal layer 40, an oriented state of the liquid crystal molecules changes according to a voltage level applied between the pixel electrode 28 and the common electrode 34, so that the liquid crystals modulate the light entering the liquid crystal layer 40 to enable gradation display. For example, in a normally white mode, the transmittance of the incident light reduces according to a voltage applied in a unit of each pixel P. In a normally black mode, the transmittance of the incident light increases according to a voltage applied in a unit of each pixel P and light according to image signals is emitted from the liquid crystal device 100 as a whole. In the present embodiment, the liquid crystal device 100 is configured assuming that the light enters from the counter substrate 30 side, passes through the liquid crystal layer 40, and is emitted from the element substrate 20.

The counter substrate 30 includes a microlens array substrate 10, a common electrode 34, and an oriented film 35. The microlens array substrate 10 is an example of an electro-optic device substrate and includes a light transmitting substrate main body 11, a lens layer 13 including microlenses ML, each of which is provided corresponding to each of the plurality of pixels P, a parting member 14 used as a light shielding film, and a path layer 31 that is an optical path length adjustment layer. The microlens array substrate 10 used as the electro-optic device substrate may include the common electrode 34 or may include the common electrode 34 and the oriented film 35.

The substrate main body 11 includes a plurality of concave portions 12 formed on the surface 11a of the liquid crystal layer 40 opposite to the surface 11b. Each concave portion 12 is provided corresponding to each pixel P. The concave portion 12 is formed to have a curved surface so that the concave portion 12 tapers toward the bottom. The concave portion 12 forms a lens surface having a convex shape of the microlens ML. Therefore, hereinafter, the concave portion 12 may be referred to as a lens surface 12. A light transmitting material such as glass or quartz is used for the substrate main body 11. The surface 11a of the substrate main body 11 corresponds to a first surface of the invention.

The lens layer 13 includes a plurality of microlenses ML formed by filling the plurality of concave portions 12, each of which is formed corresponding to each of the pixels P, on one surface 11a of the substrate main body 11. The lens layer 13 is formed of an inorganic lens material having a light transmitting property and having a refractive index n higher than that of the substrate main body 11. For example, when the substrate main body 11 is a quartz substrate having a refractive index n of about 1.46, SiON (refractive index n=1.55 to 1.64), Al₂O₃ (refractive index n=1.76), or the like is used as a lens material that forms the lens layer 13. The refractive index n depends on the wavelength of the light passing through the substrate main body 11 and the lens layer 13.

Although a detailed method of forming the lens layer 13 will be described later, a convex-shaped microlens ML is formed by forming the concave portion 12 by selectively etching one surface 11a of the substrate main body 11 and filling the concave portion 12 with the aforementioned lens material. A plurality of microlenses ML form a microlens array MLA.

The parting member 14 is provided on a flat surface 13a of the lens layer 13 opposite to the microlenses ML. The parting member 14 is provided in a peripheral area surrounding the display area E in which a plurality of microlenses ML are provided. Although not shown in FIG. 3, in the display area E, an insulating film corresponding to the arrangement of the microlenses ML is provided in the same layer as the parting member 14. Therefore, for convenience of description, the parting member 14 may be simply referred to as a light shielding film 14. The surface 13a of the lens layer 13 corresponds to a second surface of the invention.

For example, the parting member 14 can be formed of a material having a light shielding property, such as Al (aluminum), Mo (molybdenum), W (tungsten), Ti (titanium), TiN (titanium nitride), and Cr (chrome) or a laminated body of at least two materials selected from these materials. Although not shown in detail in FIG. 3, in the present embodiment, the parting member 14 has a two-layer structure in which an Al (aluminum) layer and a TiN (titanium nitride) layer are sequentially laminated from the surface 13a of the lens layer 13.

A path layer 31 that covers the parting member 14 and the surface 13a of the lens layer 13 is provided. The path layer 31 is formed of an inorganic material having a light transmitting property and, for example, having substantially the same refractive index n as that of the substrate main body 11. The path layer 31 is provided to flatten the surface of the microlens array substrate 10 facing the liquid crystal layer 40 and adjust the focal length of the microlenses ML to a desired value. Therefore, the thickness of the path layer 31 is set properly based on an optical condition such as the focal length of the microlenses ML according to the wavelength of the light.

The common electrode 34 is provided to cover the path layer 31. The common electrode 34 is a counter electrode which is formed over a plurality of pixels P and faces the pixel electrodes 28 with the liquid crystal layer 40 in between. For the common electrode 34, for example, a transparent conductive film such as ITO (Indium Tin Oxide) and IZO (Indium Zinc Oxide) is used. The common electrode 34 is arranged to face a plurality of pixel electrodes 28 with the liquid crystal layer 40 in between, so that it is preferable that the surface of the common electrode 34 is flat in order to realize desired optical characteristics for each pixel P.

The oriented film 35 is provided to cover the common electrode 34. In the same manner as the oriented film 29 on the side of the element substrate 20, the oriented film 35 is formed by using, for example, an organic material such as polyimide or an inorganic material such as silicon oxide. As described above, methods of selecting material and processing orientation of the oriented films 29 and 35 are determined by selection of liquid crystal based on the optical design of the liquid crystal device 100 and the display mode.

In the liquid crystal device 100, the light enters the counter substrate 30 including the microlenses ML (the light enters through the surface 11b of the substrate main body 11) and the light is condensed for each pixel P by the microlens ML. For example, among the light that enters the convex-shaped microlens ML through the surface 11b of the substrate main body 11, incident light L1 that enters along an optical axis that passes through the plan view center of the pixel P goes straight in the microlens ML, passes through the liquid crystal layer 40, and is emitted to the element substrate 20.

Incident light L2 which is outer than the incident light L1 and enters an outer edge portion of the microlens ML is refracted toward the plan view center of the pixel P due to a difference of the refractive indexes n between the substrate main body 11 and the lens layer 13. If the incident light L2 goes straight without change, the incident light L2 is slightly refracted when passing through the liquid crystal layer 40 and the element substrate 20, so that there is a risk that the incident light L2 enters the second light shielding layer 26 (or the first light shielding layer 22) and the incident light L2 is blocked.

In the liquid crystal device 100, even the incident light L2, which may be blocked by the second light shielding layer 26 (or the first light shielding layer 22) in this manner, can be caused to pass through the liquid crystal layer 40 and enter the opening 26a of the second light shielding layer 26 (or the opening 22a of the first light shielding layer 22) by the light condensing effect of the microlens ML. As a result, it is possible to increase the amount of light emitted from the element substrate 20, so that the utilization efficiency of the light can be improved.

### Electro-Optic Device Substrate

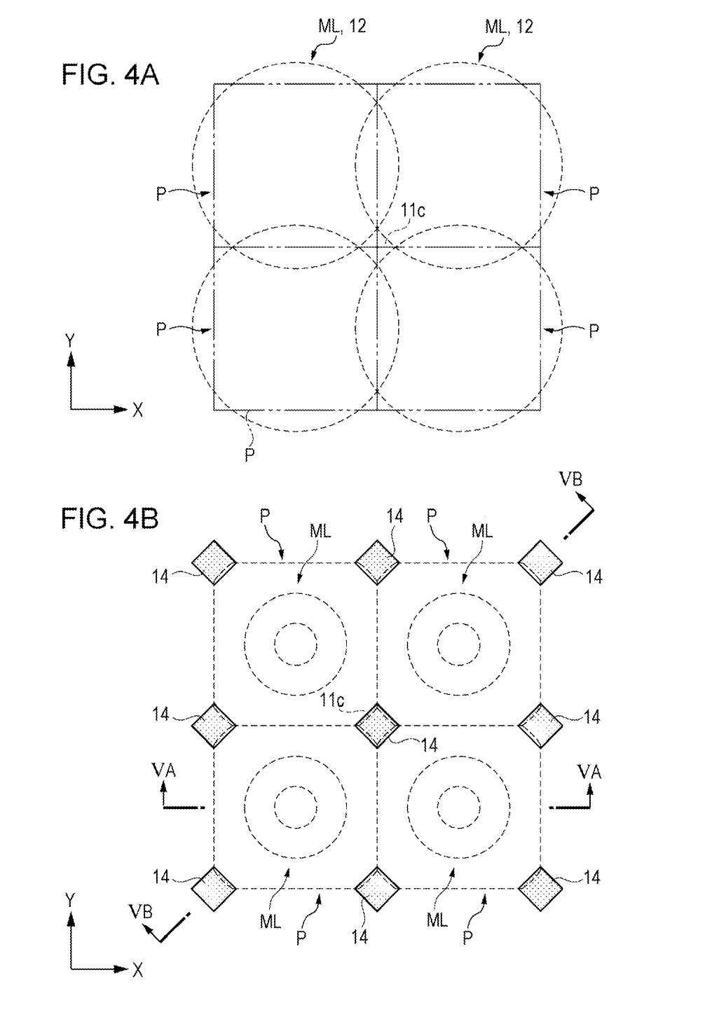

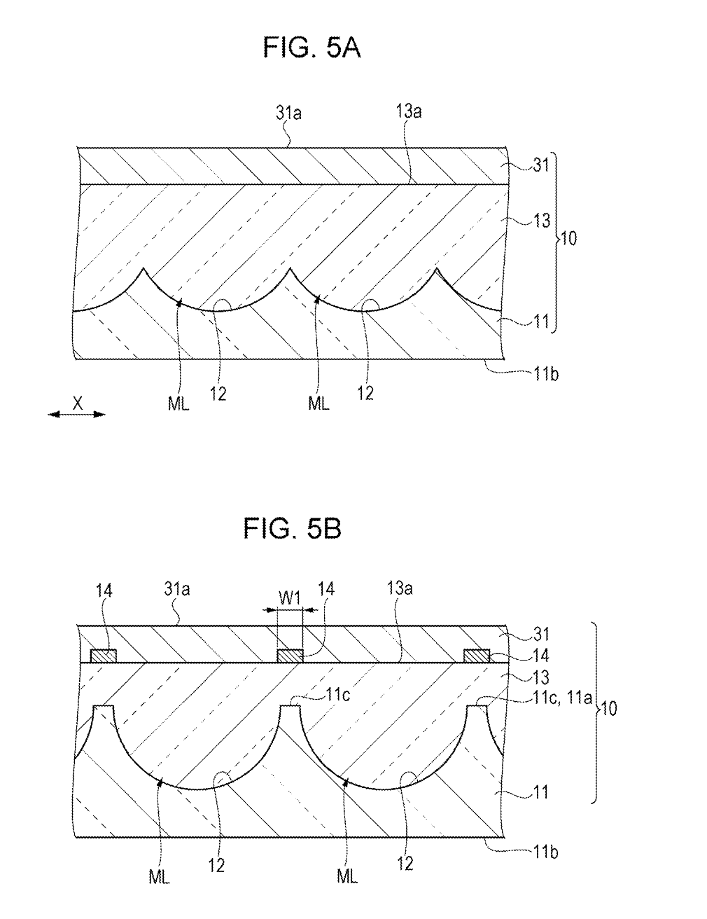

Next, the microlens array substrate 10, which is the electro-optic device substrate, will be described with reference to FIGS. 4 and 5. FIG. 4A is a schematic plan view showing arrangement of the microlenses in the microlens array substrate. FIG. 4B is a schematic plan view showing arrangement of the light shielding film with respect to the microlenses. FIG. 5A is a main portion cross-sectional view of the microlens array substrate taken along line VA-VA in FIG. 4B. FIG. 5B is a main portion cross-sectional view of the microlens array substrate taken along line VB-VB in FIG. 4B. FIGS. 4A and 4B are schematic plan views of the microlens array substrate as seen from the liquid crystal layer 40. FIGS. 5A and 5B are Z-direction upside-down main portion cross-sectional views of FIG. 3.

As shown in FIG. 4A, the microlenses ML are arranged in a matrix form in the X direction and the Y direction corresponding to the arrangement of the pixels P. As described above, the microlens ML is formed by filling the concave portion 12 of the substrate main body 11 (see FIG. 3) with the lens material and the concave portion 12 is formed to have a hemispherical surface shape tapering toward the bottom. Therefore, the position of the bottom of the concave portion 12, that is, the center of the microlens ML, substantially corresponds with the plan view center of the pixel P. In the present embodiment, the microlenses ML having a circular shape in a plan view are arranged to be partially overlapped each other in the X direction and the Y direction so that the pixel P can take in light as much as possible. Therefore, there is a straight ridge at a boundary between the microlenses ML adjacent to each other in the X direction and the Y direction. On the other hand, the microlens array substrate 10 has portions 11c in which there is no microlens ML in the diagonal direction crossing the X direction and the Y direction. The diameter of the microlens ML of the present embodiment is set to, for example, 95% of the length of the diagonal line of the pixel P. The diameter of the microlens ML may be set to 100% of the length of the diagonal line of the pixel P.

As shown in FIG. 4B, light shielding films 14 are provided to overlap the portions 11c in which there is no microlens ML. The light shielding film 14 has a substantially square shape. Although concentric circles are used to show the shape of the microlens ML in FIG. 4B, the concentric circles represent contour lines of the height of the microlens ML in the Z direction.

As shown in FIG. 5A, hemispherical shaped lens surfaces 12 (concave portions of the substrate main body 11) of the microlenses ML adjacent to each other in the X direction of the microlens array substrate 10 are in contact with each other.

On the other hand, as shown in FIG. 5B, there is a lens layer 13, in which no microlens ML is formed, between the microlenses ML adjacent to each other in the diagonal direction. The surface of the substrate main body 11 corresponding to the above portion is denoted by a symbol 11c. As described above, the light shielding film 14 is arranged to the surface 13a of the lens layer 13 corresponding to the portion 11c in which no microlens ML is formed. For example, when the diameter of the microlens ML is 95% of the length of the diagonal line of the pixel P, a width W1 in the diagonal direction of the light shielding film 14 arranged corresponding to the portion 11c in which no microlens ML is formed, that is, the length of one side of the light shielding film 14, satisfies the following formula:

w1=p1×√2×5%

Here, P1 is an arrangement pitch of the pixels P.
From the viewpoint of effectively using the light entering from the counter substrate 30, it is preferable that the width W1 of the light shielding film 14 is small as much as possible. On the other hand, if the light entering the portion 11c in which no microlens ML is formed passes through the liquid crystal layer 40 and enters the element substrate 20, there is a risk that the light becomes stray light, enters the TFT 24, and causes an optical malfunction of the TFT 24, so that it is desired that the portion 11c in which no microlens ML is formed is reliably light-shielded (see FIG. 3).

The shape of the microlens ML is not limited to a hemispherical shape, but, for example, may be a non-spherical surface shape including a cross-sectional linear portion at a rising portion of the lens surface 12 of the microlens ML on the surface 13a side of the lens layer 13.

### Manufacturing Method of Electro-Optic Device Substrate

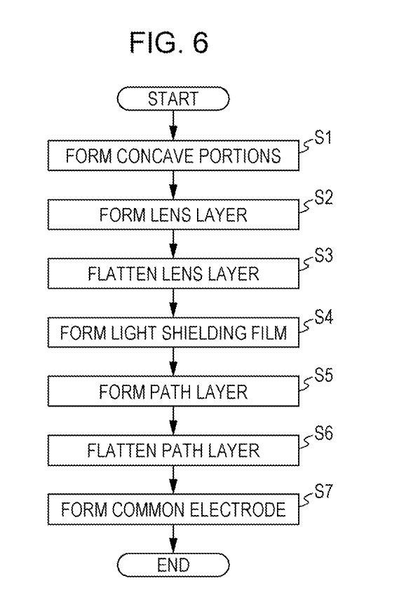

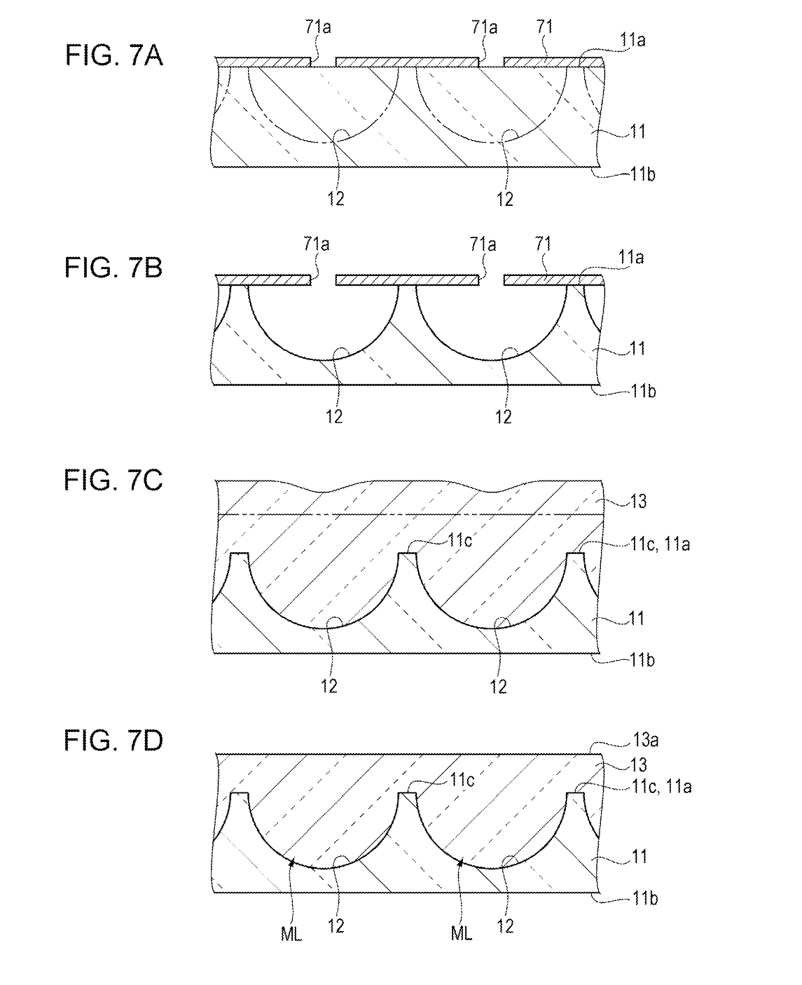

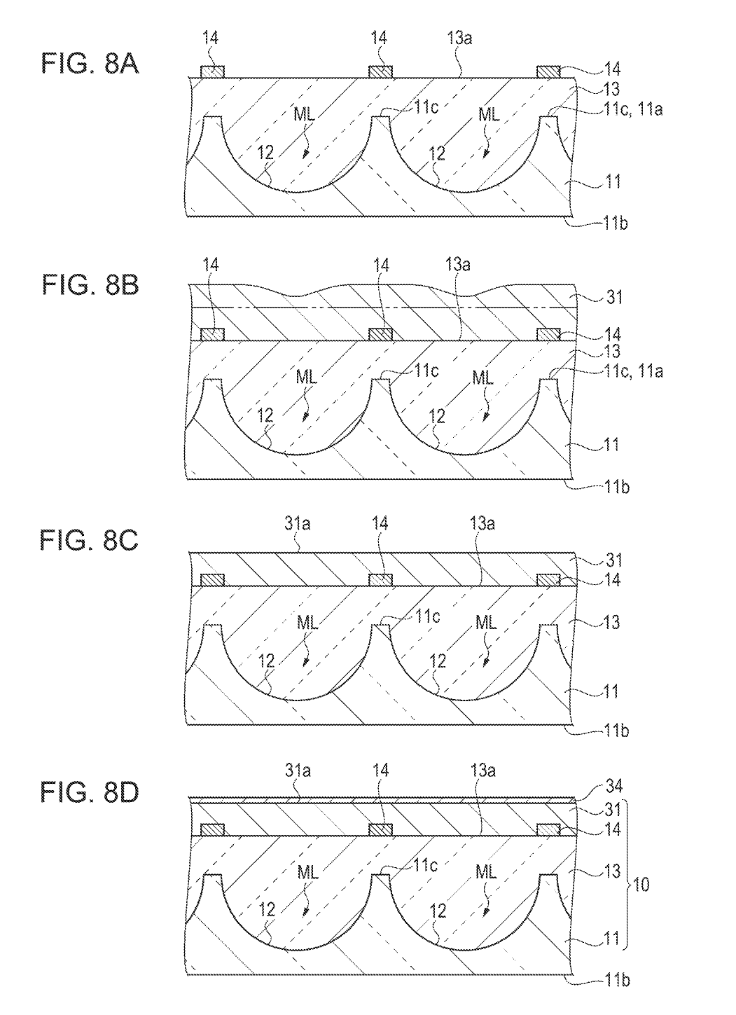

Next, the manufacturing method of the microlens array substrate 10, which is an example of the manufacturing method of the electro-optic device substrate of the present embodiment, will be described with reference to FIGS. 6 and 8. FIG. 6 is a flowchart showing the manufacturing method of the microlens array substrate. FIGS. 7A to 7D and 8A to 8D are schematic cross-sectional views showing the manufacturing method of the microlens array substrate. FIGS. 7A to 7D and 8A to 8D are schematic cross-sectional views in the diagonal direction corresponding to FIG. 5B.

As shown in FIG. 6, the manufacturing method of the microlens array substrate 10 of the present embodiment includes a concave portion formation process (step S1), a lens layer formation process (step S2), a lens layer flattening process (step S3), a light shielding film formation process (step S4), a path layer formation process (step S5), a path layer flattening process (step S6), and a common electrode formation process (step S7).

In step S1 in FIG. 6, a mask layer is formed of, for example, polycrystal silicon on the surface 11a of the substrate main body 11 formed of, for example, quartz. Then, the mask layer is patterned by using a photolithography technique and a mask 71 including openings 71a is formed. The opening 71a is formed in a position corresponding to the plan view center of the pixel P described above. The shape of the opening 71a in a plan view is a circle and the size of the opening 71a depends on the size of the concave portion 12 described above. In the present embodiment, the concave portion 12 having a length of about 10 μm in the diagonal direction in a plan view is formed, so that the diameter of the opening 71a is set to about 1.0 μm. The size of the opening 71a is not limited to this, but may be further increased according to an etching condition. FIG. 7A shows a state after the mask 71 is patterned.

Subsequently, as shown in FIG. 7B, the concave portions 12 are formed in the substrate main body 11 by performing an isotropic etching process on the substrate main body 11 through the openings 71a of the mask 71. As the isotropic etching process, for example, wet etching using etching solution such as hydrofluoric acid solution is used. The substrate main body 11 is isotropically etched from the openings 71a in surface 11a by the etching process.

As shown in FIG. 7B, the etching process stops when the concave portion 12 has a substantially hemispherical surface shape. Thereby, an area having a substantially semicircular shape in a cross-sectional view is removed and the concave portion 12 is formed. The concave portion 12 is formed to have a substantially circular shape around the opening 71a (see FIGS. 4A and 4B). Subsequently, the mask 71 is removed from the substrate main body 11. Then, the process proceeds to step S2.

Subsequently, in step S2 in FIG. 6, as shown in FIG. 7C, the lens layer 13 is formed on the surface 11a of the substrate. The lens layer 13 is formed so as to fill the concave portions 12 by using an inorganic lens material having a light transmitting property and having a refractive index n greater than that of the substrate main body 11. In the present embodiment, SiON (silicon oxide nitride) is used as the lens material for the substrate main body 11 formed of quartz, and the lens layer 13 having a thickness of about 10 μm is formed by using, for example, a CVD (Chemical Vapor Deposition) method. On the upper surface of the lens layer 13, unevenness corresponding to a plurality of concave portions 12 is generated. Then, the process proceeds to step S3.

In step S3 in FIG. 6, a flattening process is performed on the lens layer 13. In this process, the lens layer 13 is flattened by polishing the upper surface of the lens layer 13 by using, for example, a CMP (Chemical Mechanical Polishing) process. The method of the flattening process is not limited to the CMP process, but an etching back method may be used. Here, the lens layer 13 is polished to a range shown by a two-dot chain line in FIG. 7C so that a predetermined thickness of the lens layer 13 covering the surface 11a other than the concave portions 12 is about 3 μm. FIG. 7D shows a state of the lens layer 13 after the flattening process. Thereby, the microlenses ML formed by filling the concave portions 12 with the lens material are formed and the surface 13a of the lens layer 13 opposite to the microlenses ML is flattened. The predetermined thickness of the lens layer 13 along with the thickness of the path layer 31 is set properly based on an optical condition such as the focal length of the microlenses ML according to the wavelength of the light. Then, the process proceeds to step S4.

In step S4 in FIG. 6, as shown in FIG. 8A, the light shielding films 14 are formed on the surface 11a of the substrate main body 11. The light shielding film 14 is a laminated body of AL a TiN, which is formed as a film by, for example, a sputtering method. The film thickness of the laminated body is about 2 μm. Then, the laminated body is patterned by using, for example, a photolithography technique so that portions overlapping the portions 11c in which no microlens ML is formed in a plan view are left. The parting member 14 surrounding the display area E as shown in FIG. 1 or 3 is also formed by the patterning at the same time. As a method of partially removing the light shielding film 14, there is an anisotropic etching process such as dry etching. Then, the process proceeds to step S5.

In step S5 in FIG. 6, as shown in FIG. 8B, the path layer 31 covering the light shielding films 14 is formed. For the path layer 31, for example, a thick film of SiO₂ (silicon oxide) is formed by a CVD method. The thickness of the path layer 31 at this time point is about 12 μm to 13 μm. On the surface of the path layer 31, unevenness is generated due to the arrangement of the light shielding films 14. Then, the process proceeds to step S6.

In step S6 in FIG. 6, a flattening process is performed on the path layer 31. In this process, the path layer 31 is flattened by polishing the upper surface of the path layer 31 by using, for example, a CMP process. The method of the flattening process is not limited to the CMP process, but an etching back method may be used. Here, the lens layer 31 is polished to a range shown by a two-dot chain line in FIG. 8B so that a predetermined thickness of the path layer 31 is about 10.5 μm. FIG. 8C shows a state of the path layer 31 after the flattening process. Thereby, the surface 31a of the path layer 31 opposite to the light shielding films 14 is flattened. The surface 31a of the path layer 31 corresponds to a third surface of the invention. As described above, the predetermined thickness of the path layer 31 along with the thickness of the lens layer 13 is set properly based on an optical condition such as the focal length of the microlenses ML according to the wavelength of the light. Then, the process proceeds to step S7.

In step S7 in FIG. 6, as shown in FIG. 8D, a transparent conductive film formed of, for example, ITO or IZO is formed to cover the flattened surface 31a of the path layer 31. Then, the transparent conductive film is patterned to form the common electrode 34. Thereby, the common electrode 34 having a flat surface is formed. The film thickness of the common electrode 34 is about 500 μm. Thereafter, as shown in FIG. 3, the oriented film 35 covering the common electrode 34 is formed.

Although, the manufacturing method of the microlens array substrate 10 of the present embodiment has been described including the path layer flattening process in step S6 and the common electrode formation process in step S7, the manufacturing method is not limited to this. For example, if the surface of the path layer 31 covering the light shielding film 14 is sufficiently flat in the path layer formation process in step S5, the path layer flattening process in step S6 may be omitted. Further, it can be considered that the counter electrode facing the pixel electrodes 28 is not provided in the counter substrate 30 but is provided in the element substrate 20 depending on the optical design of the liquid crystal device 100. Specifically, there are methods such as IPS (In Plane Switching) and FFS (Fringe Field Switching).

According to the first embodiment described above, the following effects can be obtained:

(1) According to the microlens array substrate 10 as the electro-optic device substrate and the manufacturing method of the microlens array substrate 10, the light shielding film 14 having a function of parting is formed on the surface 13a of the flattened lens layer 13. Therefore, it is not necessary to form an interlayer film layer to flatten a surface between the path layer 31 and the common electrode 34 as compared with a case in which the light shielding film 14 is formed on the flattened surface 31a of the path layer 31, so that the manufacturing process can be simplified. In other words, it is possible to provide the microlens array substrate 10 where high productivity is achieved and the manufacturing method of the microlens array substrate 10 as compared with a case in which the interlayer film layer is formed.
(2) The light shielding films 14 are arranged so as to overlap the portions 11c in which no microlens ML is formed in the lens layer 13 in the diagonal direction crossing the X direction and the Y direction. Further, the light shielding films 14 are formed on the flattened surface 13a on the lens layer 13. Therefore, it is possible to reduce unnecessary light entering the element substrate 20 as compared with a case in which the light shielding films 14 are not formed corresponding to the portions 11c in which no microlens ML is formed.
(3) The flattening process is performed on the surface 31a of the path layer 31, so that the surface of the common electrode 34 covering the surface 31a is also flattened. In other words, display irregularity due to the unevenness of the surface of the common electrode 34 is difficult to occur.
(4) The liquid crystal device 100 that uses the microlens array substrate 10 can present a bright display as well as has excellent cost performance.

### Second Embodiment

### Electronic Device

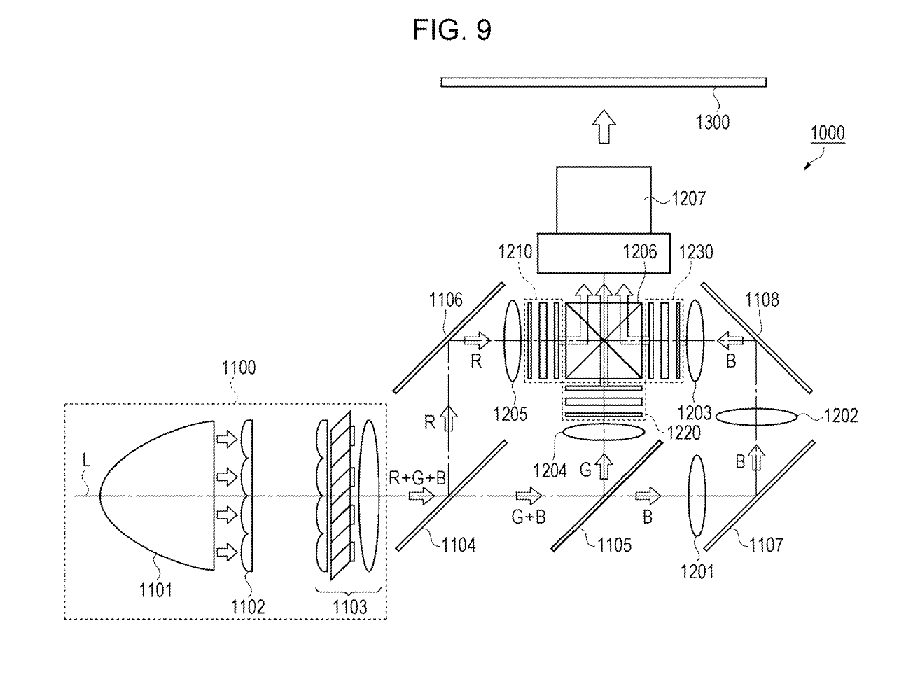

Next, a projection type display device, which is an electronic device of a second embodiment, will be described with reference to FIG. 9. FIG. 9 is a schematic diagram showing a configuration of the projection type display device.

As shown in FIG. 9, the projection type display device 1000, which is the electronic device of the present embodiment, includes a polarization illumination device 1100 arranged along a system optical axis L, two dichroic mirrors 1104 and 1105 used as light separation elements, three reflecting mirrors 1106, 1107, and 1108, five relay lenses 1201, 1202, 1203, 1204, and 1205, three transmission type liquid crystal light valves 1210, 1220, and 1230 used as light modulation means, a cross dichroic prism 1206 used as a light synthesizing element, and a projection lens 1207.

The polarization illumination device 1100 includes a lamp unit 1101 used as a light source including a white light source such as an ultra-high pressure mercury lamp and a halogen lamp, an integrator lens 1102, and a polarization conversion element 1103.

Regarding polarized light flux emitted from the polarization illumination device 1100, one dichroic mirror 1104 reflects red light (R) and transmits green light (G) and blue light (B). The other dichroic mirror 1105 reflects the green light (G) passing through the dichroic mirror 1104 and transmits the blue light (B).

The red light (R) reflected by the dichroic mirror 1104 is reflected by the reflecting mirror 1106 and then enters the liquid crystal light valve 1210 through the relay lens 1205. The green light (G) reflected by the dichroic mirror 1105 enters the liquid crystal light valve 1220 through the relay lens 1204. The blue light (B) passing through the dichroic mirror 1105 enters the liquid crystal light valve 1230 through a light guide system including three relay lenses 1201, 1202, and 1203 and two reflecting mirrors 1107 and 1108.

Each of the liquid crystal light valves 1210, 1220, and 1230 is arranged to face a light incident surface for each color light of the cross dichroic prism 1206. The color lights entering the liquid crystal light valves 1210, 1220, and 1230 are modulated based on video information (video signal) and emitted to the cross dichroic prism 1206. In this prism, four rectangular prisms are bonded together and a dielectric multilayer film that reflects red right and a dielectric multilayer film that reflects blue right are formed in a cross shape on inner surfaces of the prism. The three color lights are synthesized by these dielectric multilayer films and light that represents a color image is synthesized. The synthesized light is projected onto a screen 1300 by the projection lens 1207, which is a projection optical system, and the image is enlarged and displayed.

The liquid crystal device 100 of the first embodiment described above is applied to the liquid crystal light valve 1210. A pair of polarization elements are arranged in a cross Nicol state on a color light entering side and a color light emitting side of the liquid crystal device 100 with a gap in between. The same goes for the other liquid crystal light valves 1220 and 1230.

According to the projection type display device 1000 as described above, the liquid crystal device 100 is used as the liquid crystal light valves 1210, 1220, and 1230, so that the light utilization efficiency is improved, a bright display can be performed, and it is possible to provide the projection type display device 1000 having excellent cost performance.

The invention is not limited to the embodiments described above, but may be appropriately changed without departing from the scope or the spirit of the invention which can be read from the claims and the entire specification, and an electro-optic device substrate, a manufacturing method of the electro-optic device substrate, and an electro-optic device, which are changed in such a manner, and an electronic device to which the electro-optic device is applied are also included in the technical scope of the invention. Besides the above embodiments, various modified examples can be considered. Hereinafter, the modified examples will be described.

### Modified Example 1

In the liquid crystal device 100, as described above, the display area E may include dummy pixels. Therefore, the microlens array substrate 10 may include microlenses ML corresponding to the dummy pixels. In this case, it is preferable to form the light shielding film 14 so as to overlap the microlenses ML formed corresponding to the dummy pixels. Thereby, in the manufacturing method of the microlens array substrate 10, even if the shape of the microlenses ML located at the outermost edge of the display area E is unstable, these microlenses ML do not contribute to the actual display, so that it is possible to reduce variation of light condensing performance between pixels due to manufacturing variation of the microlenses ML.

### Modified Example 2

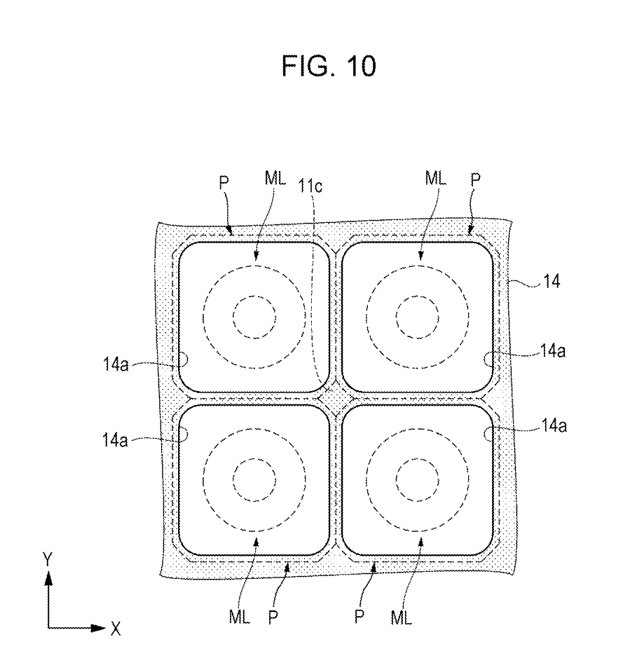

In the microlens array substrate 10, the light shielding films 14 in the display area E are not limited to be arranged so as to overlap the portions 11c in which no microlens ML is formed. FIG. 10 is a schematic plan view showing an arrangement of a light shielding film with respect to microlenses of the modified example. For example, as shown in FIG. 10, the light shielding film 14 may be arranged so as to overlap portions in which no microlens ML is formed and ridge portions that are boundaries between microlenses adjacent to each other in the X direction and the Y direction. By arranging the light shielding film 14 in this manner, the light shielding film 14 has openings 14a that define an opening area in each of a plurality of pixels P. According to the arrangement of the light shielding film 14 of the modified example, the light shielding film 14 functions as a black matrix (BM) in the display area E, so that it is possible to reduce variation of light condensing between pixels adjacent to each other and realize the liquid crystal device 100 having high contrast in display quality.

### Modified Example 3

In the microlens array substrate 10, the light shielding film 14 may be arranged as the parting member 14 without arranging the light shielding films 14 in the display area E. In this case, it is possible to realize the liquid crystal device 100 that can perform a bright display.

### Modified Example 4

The electronic device to which the liquid crystal device 100 is applied is not limited to the projection type display device 1000. For example, the liquid crystal device 100 can be preferably used as a projection type HUB (Head Up Display), an HMD (Head Mount Display), an electronic book, a personal computer, a digital still camera, a liquid crystal TV, a viewfinder type or direct-view monitor type video recorder, a car navigation system, an electronic notebook, and a display unit of an information terminal device such as a POS.

What is claimed is:

1. A manufacturing method of electro-optic device substrate, comprising:
forming a concave portion, which corresponds to a pixel, by etching a first surface of a light transmitting substrate;
forming a lens layer including a microlens formed by filling the concave portion with a lens material having a refractive index greater than that of the substrate;
flattening a second surface of the lens layer opposite to a surface in which the microlens are formed;
forming a light shielding film that surrounds a display area, in which the pixel is arranged, on the flattened second surface; and
forming a light transmitting path layer that covers the second surface on which the light shielding film is formed.

2. The manufacturing method of electro-optic device substrate according to claim 1, further comprising:
forming a transparent conductive film on a third surface of the path layer opposite to a side in contact with the lens layer.

3. The manufacturing method of electro-optic device substrate according to claim 2, further comprising:
flattening the third surface of the lens layer before the forming the transparent conductive film.

4. An electro-optic device comprising:
a pair of substrates; and
a liquid crystal layer clamped between the pair of substrates,
wherein an electro-optic device substrate manufactured by using the manufacturing method of electro-optic device substrate according to claim 1 is used as one of the pair of substrates.

5. An electronic device comprising the electro-optic device according to claim 4.
